(19) United States
(12) Patent Application Publication
(10) Pub. No.: US 2025/0055217 A1
(43) Pub. Date: Feb. 13, 2025

(54) PINS FOR USE IN LAND GRID ARRAY

(71) Applicant: Intel Corporation, Santa Clara, CA (US)

(72) Inventors: Min Pei, Camas, WA (US); Lejie Liu, Portland, OR (US); Ralph Miele, Hillsboro, OR (US); Phil Geng, Washougal, WA (US); Steven Klein, Chandler, AZ (US)

(73) Assignee: Intel Corporation, Santa Clara, CA (US)

(21) Appl. No.: 18/929,426

(22) Filed: Oct. 28, 2024

(51) Int. Cl. H01R 13/24; H01R 12/71

(52) U.S. Cl. CPC H01R 13/2442; H01R 12/716

(57) ABSTRACT

A Land Grid Array (LGA) interface assembly used to physically interface or connect a semiconductor package (e.g., a semiconductor, a microprocessor, etc.) and a PCB, motherboard, etc. The LGA interface assembly including an LGA socket including a plurality of socket pins arranged and configured to contact a plurality of contact pads on the semiconductor package to enable data transfer. The socket pins including a multi-bend and/or zig-zag configuration arranged and configured to minimize lateral displacement of the socket pin relative to the contact pad during insertion of the semiconductor package into the LGA socket. Other embodiments are described and claimed.

### BACKGROUND

A land grid array (LGA) socket provides a physical and electrical interface between a semiconductor package encapsulating a semiconductor die and a printed circuit board (PCB). The LGA socket is physically mounted on the PCB and it includes a cavity and markers to ensure the semiconductor package is inserted in the correct orientation, preventing improper installation. The underside of the semiconductor package features a grid of flat contact pads or “lands.” These pads are designed to align precisely with an array of socket pins that are spring-loaded contacts in the LGA socket. LGA sockets often include a load plate or retention mechanism to hold the semiconductor package firmly in place, providing consistent pressure and reliable contact.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates a conventional LGA stack including, inter alia, a semiconductor package and an LGA socket.

FIG. 1B illustrates a conventional semiconductor package including a plurality of pads.

FIG. 1C illustrates a conventional LGA socket surface mounted to a PCB, the LGA socket including a plurality of socket pins.

FIG. 2 illustrates a conventional socket pin illustrated in its original and deformed states.

FIG. 3A illustrates a socket pin in accordance with one embodiment of the present disclosure.

FIG. 3B illustrates the socket pin of FIG. 3A in its original and deformed states.

FIG. 3C illustrates a perspective view of the socket pin of FIG. 3A in its deformed state.

FIG. 4A illustrates a socket pin in accordance with a second embodiment of the present disclosure.

FIG. 4B illustrates the socket pin of FIG. 4A in its original and deformed states.

FIG. 5 illustrates a socket pin in accordance with a third embodiment of the present disclosure.

FIG. 6A illustrates a socket pin in accordance with a fourth embodiment of the present disclosure, the socket pin illustrated in its original state.

FIG. 6B illustrates the socket pin of FIG. 6A, the socket pin illustrated in its deformed state at a first level of vertical displacement.

FIG. 6C illustrates the socket pin of FIG. 6A, the socket pin illustrated in its deformed state at a second level of vertical displacement.

FIG. 7A illustrates the conventional socket pin of FIG. 2, the socket pin of FIG. 3A, and the socket pin of FIG. 4A in their original states.

FIG. 7B illustrates the conventional socket pin of FIG. 2, the socket pin of FIG. 3A, and the socket pin of FIG. 4A in their deformed states at a first level of vertical displacement.

FIG. 7C illustrates the conventional socket pin of FIG. 2, the socket pin of FIG. 3A, and the socket pin of FIG. 4A in their deformed states at a second level of vertical displacement.

FIG. 7D illustrates the conventional socket pin of FIG. 2, the socket pin of FIG. 3A, and the socket pin of FIG. 4A in their deformed states at first and second levels of vertical displacement.

FIG. 8 illustrates a computing architecture in accordance with one embodiment of the present disclosure.

### DETAILED DESCRIPTION

Embodiments generally relate to a Land Grid Array (LGA) interface assembly to physically and electrically interface or connect a semiconductor package (e.g., a semiconductor die, a microprocessor, etc.) and a circuit board such as a PCB. In some embodiments, an LGA interface assembly includes a LGA socket, which may be surface mounted to a PCB, such as a motherboard of a computing system. The semiconductor package includes a plurality of pads on a bottom surface of the package. The LGA socket includes a first or top surface, a second or bottom surface opposite the first or top surface, the second or bottom surface being arranged and configured to connect to the PCB, and a plurality of socket pins mounted to, or associated with, the first or top surface (terms first, top, second, bottom, used interchangeably herein without the intent to limit or distinguish). The plurality of socket pins are arranged and configured to contact the plurality of pads on the semiconductor package to enable data transfer when the semiconductor package is inserted into the LGA socket. In some embodiments, at least one of the socket pins is arranged and configured to contact at least one corresponding contact pad of the contact pads.

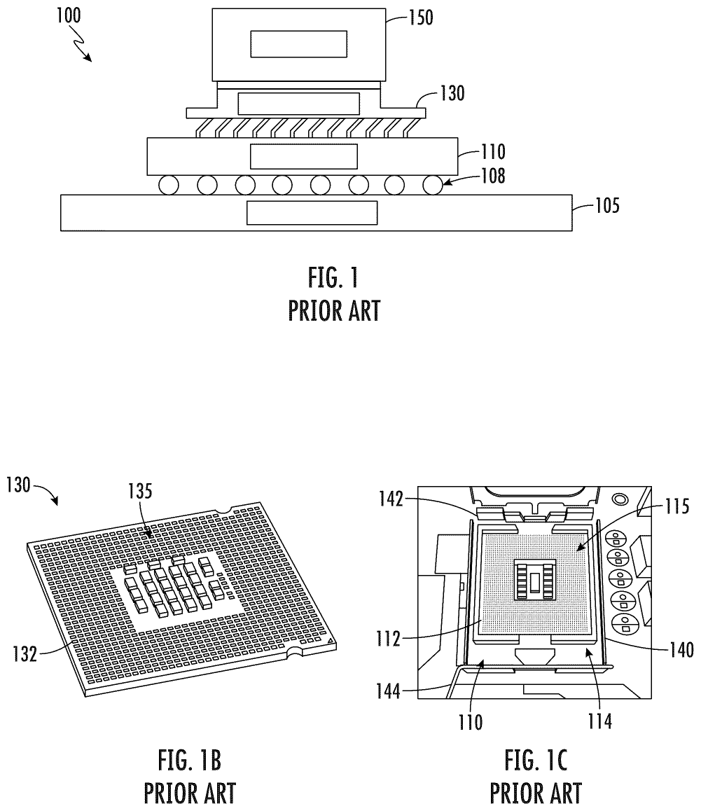

FIGS. 1A-1C illustrate an example embodiment of a conventional LGA interface assembly 100 suitable for use in connecting a semiconductor package to a PCB in a computing system. As depicted in FIG. 1A, the LGA interface assembly 100 includes an LGA socket 110 arranged and configured to receive a semiconductor package 130. The semiconductor package 130 may encapsulate a semiconductor device, such as a semiconductor die or an integrated circuit (IC). Non-limiting examples of a semiconductor device includes semiconductor dies, ICs, memory ICs, chipsets, accelerators, controllers, transceivers, and so forth. A particular example of a semiconductor device comprises different processing units, collectively referred to as an “XPU,” where X stands for different letters depending on the context or specific function of the processing unit, which represents a shift towards more specialized, task-specific processors. Examples of an XPU include a central processing unit (CPU), graphics processing unit (GPU), data processing unit (DPU), vision processing unit (VPU), neural processing unit (NPU), infrastructure processing unit (IPU), tensor processing unit (TPU), and other processing units. The LGA socket 110 may be surface mounted to a PCB 105 such as, for example, by soldering 108, although this is but one embodiment.

With additional reference to FIG. 1B, the semiconductor package 130 includes a bottom or contacting surface 132, which includes a plurality of contact pads 135. With additional reference to FIG. 1C, the LGA socket 110 includes a first or top surface 112, a second or bottom surface 114 opposite the first surface 112, the second surface 114 being arranged and configured to connect to the PCB 105, and a plurality of socket pins 115 extending from the first surface 112. Each of the socket pins 115 being mounted to, or associated with, the LGA socket 110. For example, each socket pin 115 may be embedded or potted within the LGA socket 110, although this is but one embodiment. In use, each of the socket pins 115 is arranged and configured to contact one of the contact pads 135 formed on the semiconductor package 130 when the semiconductor package 130 is inserted into the LGA socket 110. For example, in use, a semiconductor package 130 may be inserted into the LGA socket 110 such that the contact pads 135 are positioned in face-to-face contact with the socket pins 115.

As further depicted, the semiconductor package 130 may include a heatsink 150. The LGA interface assembly 100 may further include a metal load plate 140 coupled to the first surface or the second surface, the metal load plate 140 including a hinge 142 to pivot over the semiconductor package 130 once inserted into the LGA socket 110. A lever 144 coupled to the metal load plate 140 may also be provided, the lever 144 being arranged and configured to lock the semiconductor package 130 in place when inserted into the LGA socket 110. In use, the LGA socket 110 comprises a mechanical interface and an electrical interface to connect the semiconductor package 130 to the PCB. The LGA socket 110 enables the semiconductor package 130 to be positioned within the LGA socket 110 and be disconnected from the LGA socket 110. Contact between the socket pins 115 and the contact pads 135 enabling data transfer between the semiconductor package 130 and the LGA socket 110 to the PCB 105.

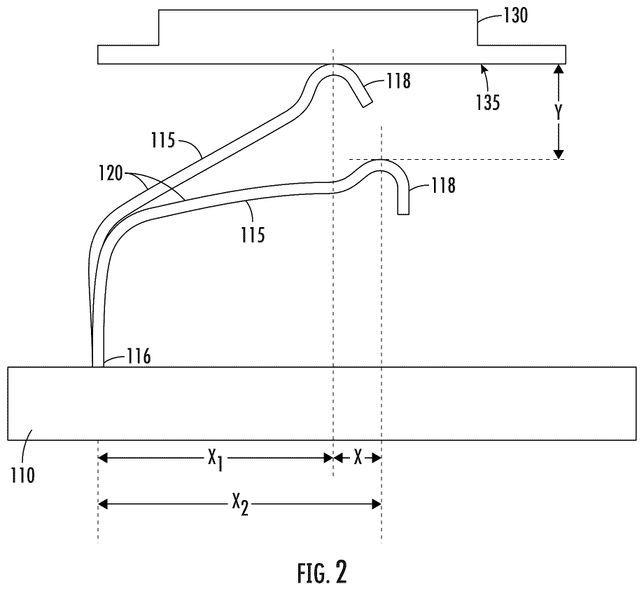

One problem generally associated with existing socket pins 115 concerns lateral displacement of the contact tip 118 of the socket pin 115. That is, with reference to FIG. 2, each socket pin 115 includes a first end or base 116, which is arranged and configured to couple with the LGA socket 110. In addition, each socket pin 115 includes a second end or contact tip 118 opposite the base 116, the contact tip 118 arranged and configured to contact the contact pad 135 of the semiconductor package 130. As depicted in FIG. 2, an intermediate arm, portion, or segment 120 of the socket pin 115 is positioned between the base 116 and the contact tip 118. As depicted, in one embodiment, each socket pin 115 is integrally or monolithically formed.

As depicted in FIG. 2, during insertion or positioning of the semiconductor package 130 into the LGA socket 110, vertical displacement Y of the semiconductor package 130 into the LGA socket 110 causes vertical displacement Y of the socket pins 115, which results in lateral displacement X of the contact tip 118 against the contact pad 135. Moreover, thereafter, cyclic vibrational loads may cause movement of the semiconductor package 130 relative to the LGA socket 110. That is, with the socket pins 115 coupled to the LGA socket 110, vertical displacement Y of the semiconductor package 130 relative to the LGA socket 110 causes the socket pins 115 to tilt or bend in a single direction resulting in lateral displacement of the contact tip 118 against the contact pad 135. For example, the vertical displacement Y of the semiconductor package 130 relative to the socket pins 115 causes the socket pins 115 to deform and/or deflect, which results in lateral displacement of the contact tips 118 against the contact pads 135. Vertical displacement of the Y of the socket pins 115 may be caused during initial positioning of the semiconductor package 130 into the LGA socket 110 and subsequently during use due to cyclic vibrational loading. Vertical displacement caused by cyclic vibrational loading may result in fretting (i.e., lateral displacement of the contact tip 118 against the contact pad 135 may cause scratching of the gold-plated surfaces on the contact pads 135 and/or contact tips 118, which may lead to increased electrical resistance and deterioration of performance).

As illustrated in FIG. 2, current socket pins 115 are arranged and configured to tilt in one direction similar to a cantilever so that vertical loading on the contact tip 118 of the socket pin 115 forces the contact tip 118 to slide along the contact pad 135. For example, as depicted in FIG. 2, during initial positioning of the semiconductor package 130 into the LGA socket 110, a vertical displacement Y of the semiconductor package 130 causes the contact tip 118 to laterally displace from its original state X₁ to its displaced or deformed state X₂. In one embodiment, a vertical displacement Y of 0.45 mm causes approximately 242 μm of lateral displacement (X₂-X₁). Thereafter, the semiconductor package 130 and LGA socket 110 may experience or be subjected to cyclic vibrational loads. During cyclic vibrational loads, smaller vertical displacements Y may be experienced. For example, a vertical displacement Y of 0.1 mm may be experienced (e.g., the semiconductor package 130 may be vertically displaced between the 0.45 mm position and a 0.35 mm position), which may cause, for example, 55 μm of lateral displacement.

Lateral displacement, especially caused by cyclic vibrational loading, causes numerous disadvantages. For example, excessive lateral displacement may cause vibrational and durability risks. Currently vibrational and durability risks are mainly controlled by increasing the stack load. Increased stack load is used to deform the semiconductor package to force tighter contact along the edge of the package. However, high stack load causes increased design requirements, increased material costs and tradeoffs associated with the loading mechanism. Warpage shape fine tuning requires increased process control, which results in higher development costs and manufacturing costs. In addition, excessive lateral displacement may cause fretting. That is, lateral displacement of the contact tip 118 against the contact pad 135 may cause scratching of the gold-plated surface on the contact pads 135, which may lead to increased electrical resistance and deterioration of performance. Moreover, excessive lateral displacement may cause increased contact pad sizes. In use, each contact pad 135 must be of a size sufficient to accommodate the contact tip 118 in its original and deformed states, thus the greater the lateral displacement, the greater the size of the contact pad 135. However, conventional socket pins 115 such as that depicted in FIG. 2 are not arranged and configured to control and/or are not optimized for lateral displacement.

Thus, by reducing the lateral displacement of the contact tip 118 of the socket pin 115 during insertion of the semiconductor package 130 into the LGA socket 110 and/or during cyclic vibrational loading, these disadvantages can be eliminated, or at least minimized.

As will be described herein, the present disclosure is directed to novel socket pins arranged and configured to eliminate, or at least reduce, lateral displacement of the contact tip relative to the contact pad. As such, the present disclosure should not be limited to any specific LGA interface assembly 100 unless explicitly claimed. By providing a socket pin, which eliminates, or at least reduces, lateral displacement, friction fretting energy can be reduced, which enables reduced LGA stack loads, reduced costs, simpler designs, and increased design space for packaging design.

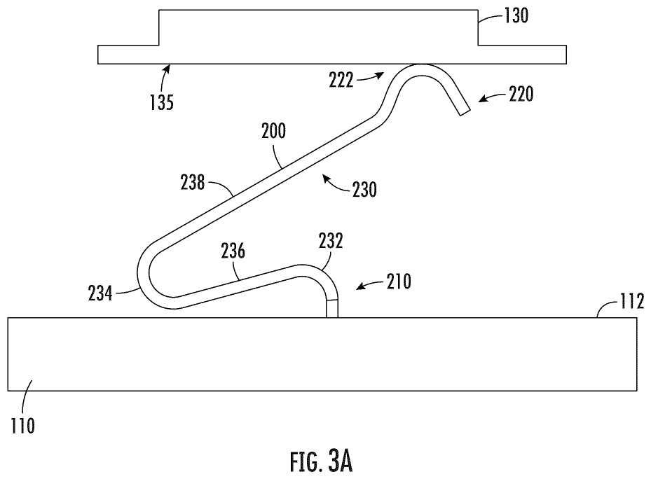

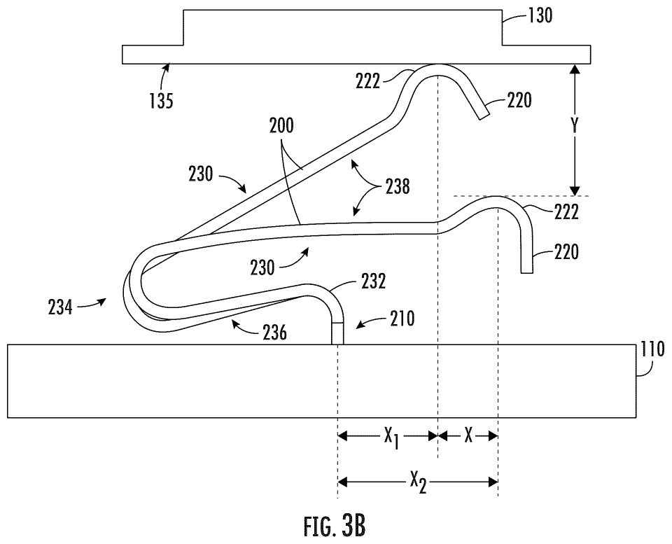

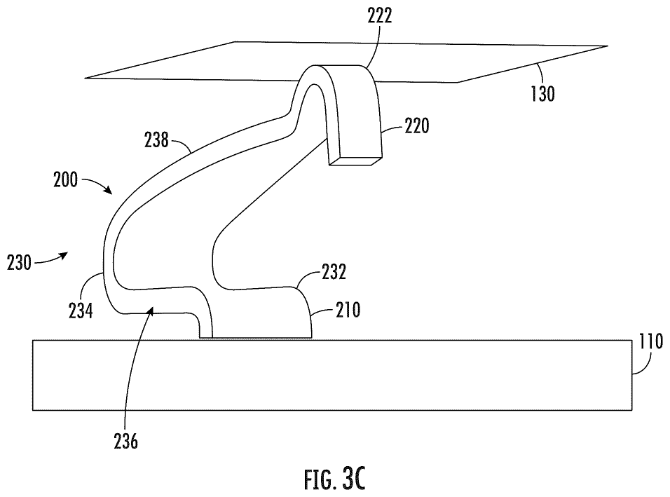

With reference to FIGS. 3A-3C, a first embodiment of a socket pin 200 in accordance with one or more features of the present disclosure is illustrated. As illustrated, the socket pin 200 includes a first end or base 210, a second end 220, and an intermediate segment 230 positioned between the base 210 and the second end 220. The base 210 is arranged and configured to mount, engage, or be associated with, the first or top surface of the physical interface or LGA socket such as, for example, LGA socket 110. For example, the base 210 may be embedded within the LGA socket 110, although other coupling mechanisms are envisioned. The second end 220 includes a contact tip 222 for connecting with a contact pad on the semiconductor package such as, for example, contact pad 135 of the semiconductor package 130.

As depicted, the intermediate segment 230 may be constructed as a flexible pin body between the first end or base 210 and the second end 220, the flexible pin body comprising a flexible material to allow the contact tip 222 to move from a first position (e.g., original state) to a second position (e.g., a deformed state) in a vertical direction perpendicular to the first surface of the physical interface or LGA socket 110. The intermediate segment 230 being arranged and configured to limit movement of the contact tip 222 in a horizontal direction parallel to the first or top surface to within a defined length when in the second position.

As depicted, in one embodiment, the intermediate segment 230 may include multiple bends such as, for example, a first bend 232 and a second bend 234. Thus arranged, the intermediate segment 230 may include first and second sub-segments 236, 238 as defined by the first and second bends 232, 234. That is, as depicted, the socket pin 200 may include multiple segments and multiple bends between segments. For example, as depicted, the socket pin 200 may include a base 210, a first bend 232 positioned adjacent to the base 210 (e.g., a short distance or segment therefrom), a first sub-segment 236 extending from the first bend 232 to the second bend 234, and a second sub-segment 238 positioned between the second bend 234 and the contact tip 222 (e.g., a first bend positioned between a first segment and the base, and a second bend between the first segment and a second segment).

In the depicted embodiment, the first bend 232 bends in an opposite direction as the second bend 234 (e.g., the first bend 232 bends towards the second bend 234). As such, the first sub-segment 236 may extend in an opposite lateral direction as compared to the second sub-segment 238 such that, at least a portion of the second sub-segment 238 is positioned vertically above the first sub-segment 236. In addition, and/or alternatively, in some embodiments, as illustrated, the first bend 232 may cause the first sub-segment 236 to extend in a negative direction. That is, the first bend 232 may be arranged and configured with a negative angle (e.g., an angle of less than 90-degrees relative to a first surface 112 of the LGA socket 110) so that the first sub-segment 236 bends or extends towards the first surface 112 of the LGA socket 110. For example, as illustrated, the first sub-segment 236 may extend at an angle of approximate −15° relative to a plane of the first surface 112, although this is but one embodiment and it is envisioned that the first sub-segment 236 may extend at an angle of approximate +45° to −30° relative to a plane of the first surface 112. In one embodiment, the length of the second sub-segment 238 may be approximately 900 μm. The length of the first sub-segment 236 may be approximately 420 μm, without considering turning portion. Turn radius may be 110 μm, although these are just exemplary and other dimensions and/or angles may be used. In use, by extending the length of the first sub-segment 236, lateral displacement of the contact tip 222 may be reduced. In one embodiment, the length of the first sub-segment 236 may be between 0 mm and 1.5 mm with the second bend 234 being approximately +45°.

FIG. 3B illustrates the socket pin 200 in its first and second positions (e.g., original and deformed states). As depicted, by providing a multi-bend design, reduced lateral displacement and fretting energy is obtained. For example, a vertical displacement Y of the semiconductor package 130 causes the contact tip 222 to laterally displace from its original state X₁ to its displaced or deformed state X₂. In one embodiment, during initial positioning of the semiconductor package 130 into the LGA socket 110 (e.g., during a vertical displacement of approximately 0.45 mm), lateral displacement of the contact tip 222 relative to the base 210 (e.g., defined length) is approximately 217 μm. Thereafter, the semiconductor package 130 and LGA socket 110 may experience or be subjected to cyclic vibrational loads. During cyclic vibrational loads, smaller vertical displacements Y may be experienced. For example, a vertical displacement Y of 0.1 mm may be experienced (e.g., the semiconductor package 130 may be vertically displaced between the 0.45 mm position and a 0.35 mm position), which may cause, for example, 42 μm of lateral displacement. An approximate 22 percent decrease in lateral displacement due to cyclic vibrational loading and a 16 percent decrease in frictional energy due to cyclic vibrational loading when compared to a conventional socket pin such as socket pin 115 previously described.

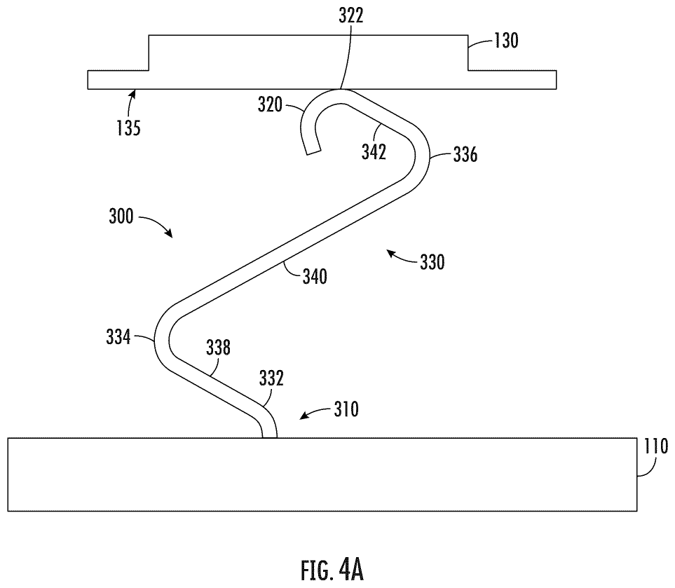

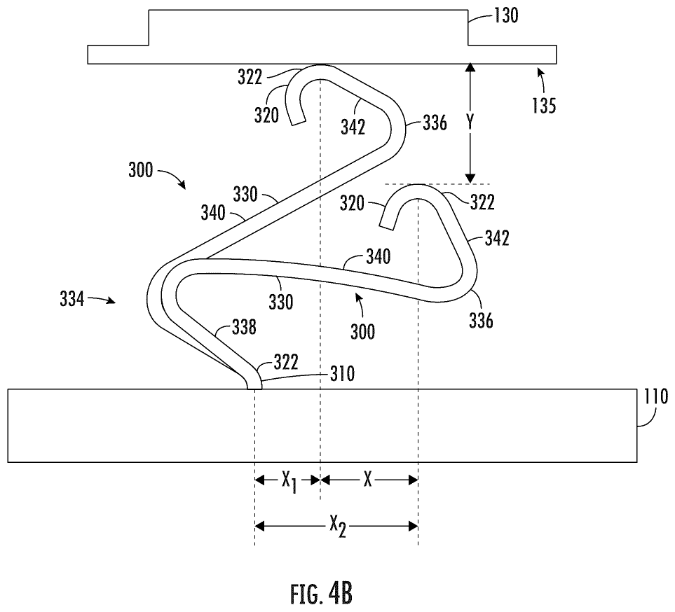

With reference to FIGS. 4A and 4B, a second embodiment of a socket pin 300 in accordance with one or more features of the present disclosure is illustrated. As illustrated, the socket pin 300 includes a first end or base 310, a second end 320, and an intermediate segment 330 positioned between the base 310 and the second end 320. The base 310 is arranged and configured to mount, engage, or be associated with, the first or top surface of the physical interface or LGA socket such as, for example, LGA socket 110. For example, the base 310 may be embedded within the LGA socket 110, although other coupling mechanisms are envisioned. The second end 320 includes a contact tip 322 for connecting with a contact pad on the semiconductor package such as, for example, contact pad 135 of the semiconductor package 130.

As depicted, the intermediate segment 330 may be constructed as a flexible pin body between the first end or base 310 and the second end 320, the flexible pin body comprising a flexible material to allow the contact tip 322 to move from a first position (e.g., original state) to a second position (e.g., a deformed state) in a vertical direction perpendicular to the first or top surface of the physical interface or LGA socket 110. The intermediate segment 330 being arranged and configured to limit movement of the contact tip 322 in a horizontal direction parallel to the first or top surface to within a defined length when in the second position.

As depicted, in one embodiment, the intermediate segment 330 may include multiple bends such as, for example, first, second, and third bends 332, 334, 336. Thus arranged, the intermediate segment 330 may include first, second, and third sub-segments 338, 340, 342 as defined by the first, second, and third bends 332, 334, 336. That is, as depicted, the socket pin 300 may include multiple segments and multiple bends between segments. For example, as depicted, the socket pin 300 may include a base 310, a first bend 332 positioned adjacent to the base 310 (e.g., a short distance or segment therefrom), a first sub-segment 338 extending from the first bend 332 to the second bend 334, a second sub-segment 340 extending from the second bend 334 to the third bend 336, and a third sub-segment 342 positioned between the third bend 336 and the contact tip 322 (e.g., a first bend positioned between a first segment and the base, a second bend between the first segment and a second segment, and a third bend between the second segment and a third segment).

In the depicted embodiment, the first bend 332 bends in an opposite direction as the second bend 334 (e.g., the first bend 332 bends towards the second bend 334). Similarly, the third bend 336 bends in an opposite direction as the second bend 334 (e.g., the third bend 336 bends towards the second bend 334). Thus, as depicted, the first and third bends 332, 336 bend in the same direction and opposite the direction of bend of the second bend 334. As such, the first sub-segment 338 may extend in an opposite lateral direction as compared to the second sub-segment 340 such that, at least a portion of the second sub-segment 340 is positioned vertically above the first sub-segment 338. Similarly, the third sub-segment 342 may extend in an opposite lateral direction as compared to the second sub-segment 340 such that, at least a portion of the third sub-segment 342 is positioned vertically above the second sub-segment 340. As depicted, and thus arranged, the first and third sub-segments 338, 342 may extend in the same direction.

In one embodiment, the first sub-segment 338 may have a length of approximately 300 μm. The second sub-segment 340 may have a length of approximately 900 μm. The third sub-segment 342 may have a length of approximately 200 μm. The turn radius for the first, second, and third bends 332, 334, 336 may be approximately 110 μm. The first sub-segment 338 and the third sub-segment 342 may extend at an angle of approximately 60° relative to a top surface of the LGA socket 110 while the second sub-segment 340 may extend at an angle of −60° relative to a top surface of the LGA socket 110. In some embodiments, if the second bend 334 and the third bend 336 have the same angle and if the length of the first sub-segment 338 and the length of the third sub-segment 342 add up to be the same as the length of the second sub-segment 340, then the lateral displacement of the contact pin 322 can be minimized.

In addition, and/or alternatively, as depicted, the contact point 322 is lateral displaced or offset relative to the base 310 to provide increased stability. In one embodiment, the contact point 322 may be laterally offset relative to the base 310 by 200 μm or greater. In one embodiment, the lateral offset was 236 μm. In another embodiment, the lateral offset was 1080 μm, although these are just examples and other suitable offsets can be utilized to maintain stability.

FIG. 4B illustrates the socket pin 300 in its original and deformed states. As depicted, by providing a multi-bend or zig-zag design, reduced lateral displacement and fretting energy is obtained. For example, during initial positioning of the semiconductor package 130 into the LGA socket 110, a vertical displacement Y of the semiconductor package 130 causes the contact tip 322 to laterally displace from its original state X₁ to its displaced or deformed state X₂. In one embodiment, a vertical displacement Y of approximately 0.45 mm causes approximately 402 μm of lateral displacement of the contact tip 222 relative to the base 210 (e.g., defined length). Thereafter, the semiconductor package 130 and LGA socket 110 may experience or be subjected to cyclic vibrational loads. During cyclic vibrational loads, smaller vertical displacements Y may be experienced. For example, a vertical displacement Y of 0.1 mm may be experienced (e.g., the semiconductor package 130 may be vertically displaced between the 0.45 mm position and a 0.35 mm position), which may cause, for example, 34 μm of lateral displacement. An approximate 38 percent decrease in lateral displacement due to cyclic vibrational loading and a 39 percent decrease in frictional energy due to cyclic vibrational loading when compared to a conventional socket pin such as socket pin 115 previously described.

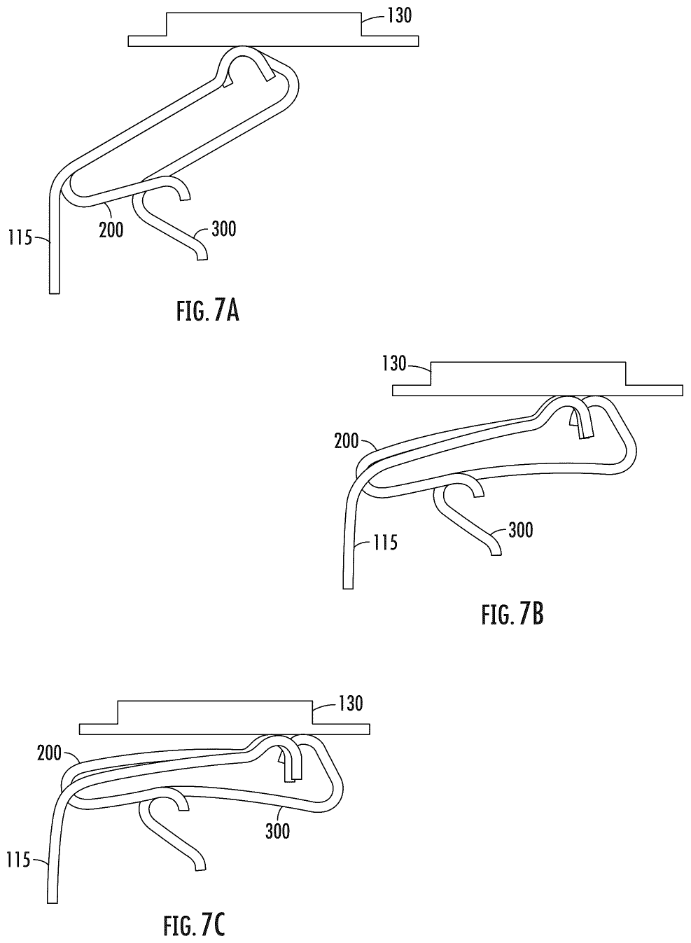

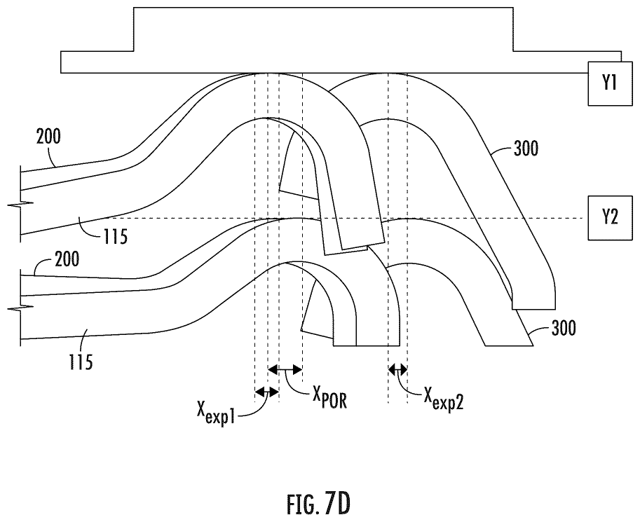

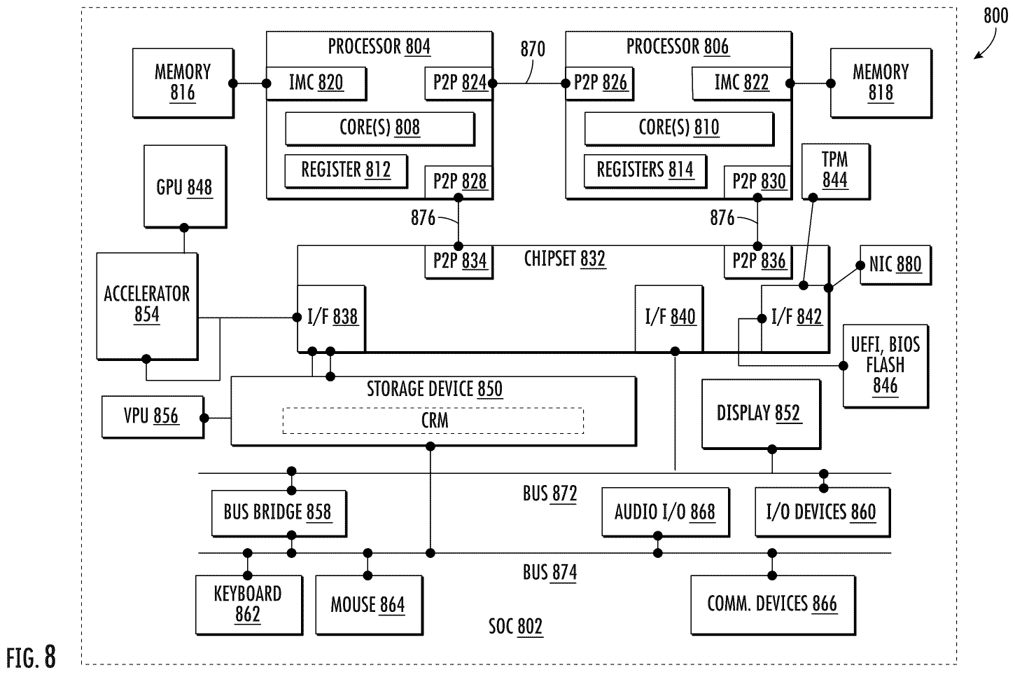

With reference to FIGS. 7A-7C, convention socket pin 115, socket pin 200, and socket pin 300 are overlaid with each other to depict relative lateral displacement caused by vertical displacement of the semiconductor package relative to the LGA socket. FIG. 7A depicts the socket pins 115, 200, 300 in their original state. FIG. 7B depicts the socket pins 115, 200, 300 in a deformed state with a vertical displacement Y of 0.3 mm, which may be caused during cyclic vibrational loads, which causes the semiconductor package to move relative to the LGA socket. FIG. 7C depicts the socket pins 115, 200, 300 in a deformed state with a vertical displacement Y of 0.45 mm, which may be caused during initial positioning of the semiconductor package into the LGA socket. With additional reference to FIG. 7D, which depicts the relative lateral displacement of the socket pins 115, 200, 300 caused during cyclic vibrational loads (e.g., vertical displacement of the socket pins caused by the semiconductor package moving relative to the LGA socket) (FIG. 7D illustrates the fretting caused by the socket pins as they move between FIG. 7B (0.3 mm vertical compression) and FIG. 7C (0.45 mm vertical compression). As illustrated, socket pin 300 undergoes lateral displacement Xexp2, socket pin 200 undergoes lateral displacement Xexp1, and conventional socket pin 115 undergoes lateral displacement Xpor, wherein lateral displacement Xexp2 is less than lateral displacement Xexp1, which is less than lateral displacement Xpor. Xexp2 is 34 μm, Xexp1 is 42 μm, and Xpor is 55 μm.

As such, by providing a socket pin 200, 300 with a multi-bend and/or zig-zag configuration, reduced lateral displacement is achieved. In addition, the socket pin designs provide for reduced bending moments, more concentrated stress, and a stiffer design thereby enabling a thinner structure to be utilized.

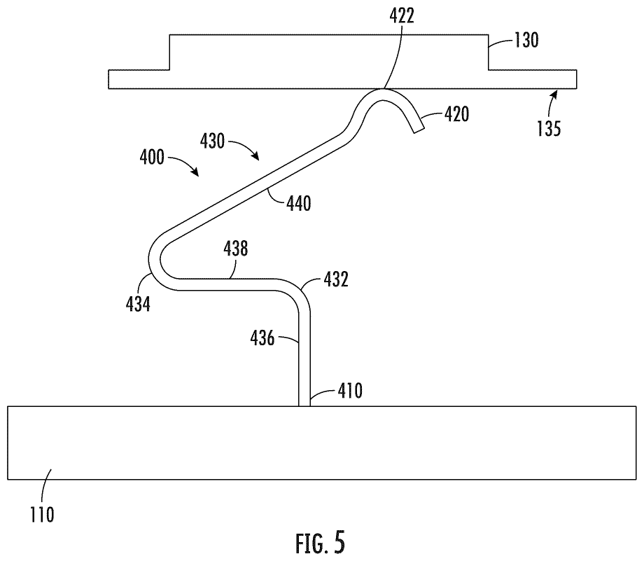

With reference to FIG. 5, a third embodiment of a socket pin 400 in accordance with one or more features of the present disclosure is illustrated. As illustrated, the socket pin 400 includes a first end or base 410, a second end 420, and an intermediate segment 430 positioned between the base 410 and the second end 420. The base 410 is arranged and configured to mount, engage, or be associated with, the first or top surface of the physical interface or LGA socket such as, for example, LGA socket 110. For example, the base 410 may be embedded within the LGA socket 110, although other coupling mechanisms are envisioned. The second end 420 includes a contact tip 422 for connecting with a contact pad on the semiconductor package such as, for example, contact pad 135 of the semiconductor package 130.

As depicted, the intermediate segment 430 may be constructed as a flexible pin body between the first end or base 410 and the second end 420, the flexible pin body comprising a flexible material to allow the contact tip 422 to move from a first position (e.g., original state) to a second position (e.g., a deformed state) in a vertical direction perpendicular to the first or top surface of the physical interface or LGA socket 110. The intermediate segment 430 being arranged and configured to limit movement of the contact tip 422 in a horizontal direction parallel to the first or top surface to within a defined length when in the second position.

As depicted, in one embodiment, the intermediate segment 430 may include multiple bends such as, for example, a first bend 432 and a second bend 434. In addition, the intermediate segment 430 may include first, second, and third sub-segments 436, 438, 440 as defined by the base 410 and the first and second bends 432, 434. That is, as depicted, the socket pin 400 may include multiple segments and multiple bends between segments. For example, as depicted, the socket pin 400 may include a base 410, a first sub-segment 436 extending from the base 410, a first bend 432 extending from the first sub-segment 436, a second sub-segment 438 extending from the first bend 432 to the second bend 434, and a third sub-segment 440 positioned between the second bend 434 and the contact tip 422 (e.g., a first segment positioned between the base and a first bend, the first bend positioned between the first segment and a second segment, and a second bend between the second segment and a third segment).

In the depicted embodiment, the first sub-segment 436 extends vertically from the top surface of the LGA socket 110. The first bend 432 bends in an opposite direction as the second bend 434 (e.g., the first bend 432 bends towards the second bend 434). As such, the second sub-segment 438 may extend in an opposite lateral direction as compared to the third sub-segment 440 such that, at least a portion of the third sub-segment 440 is positioned vertically above the second sub-segment 438. In addition, and/or alternatively, in some embodiments, as illustrated, the first bend 432 may cause the second sub-segment 438 to extend substantially perpendicular relative to the first sub-segment 436. In one embodiment, as illustrated, the base 410 is approximately positioned in the middle of the third sub-segment 440 (e.g., in the middle between the second bend 434 and the contact tip 422). In some embodiments, the length of the second sub-segment 438 may be approximately 0 to 1.4 mm or higher. In the depicted embodiment, the length of the second sub-segment 438 is approximately 450 μm. In one embodiment, the first bend 432 and the second bend 434 may have a bend radius of 110 μm.

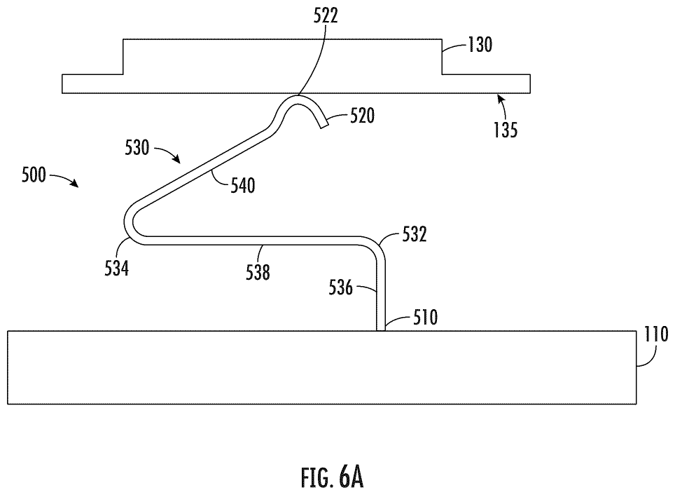

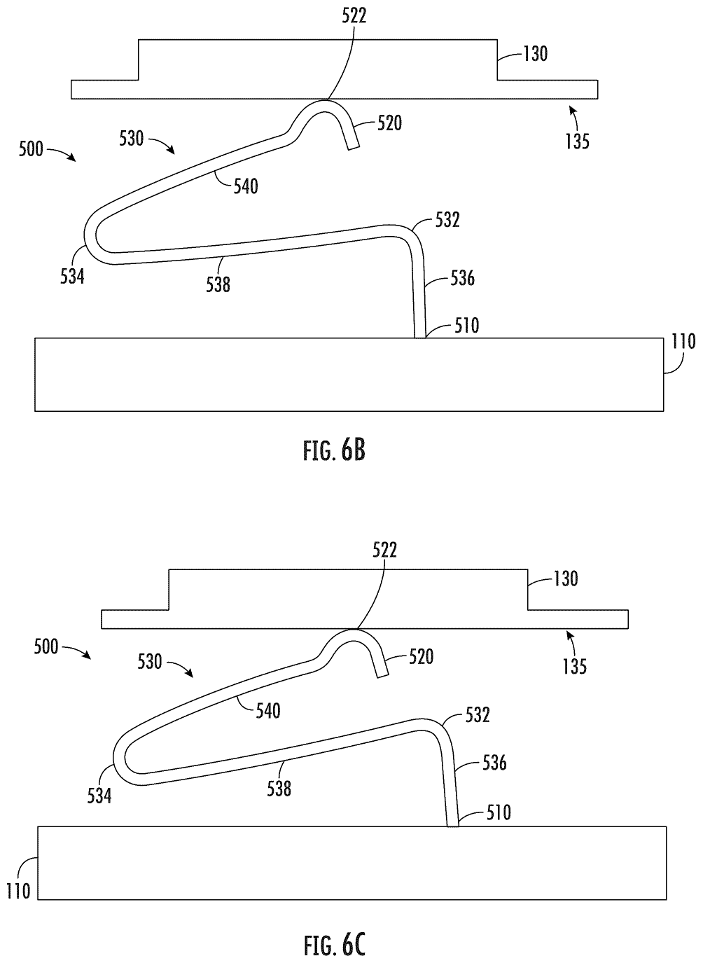

FIGS. 6A-6C depict a fourth embodiment of a socket pin 500, which is substantially similar to socket pin 400 previously described herein, except for the length of second sub-segment 538. Thus, as depicted, the socket pin 500 includes a first end or base 510, a second end 520, and an intermediate segment 530 positioned between the base 510 and the second end 520. The base 510 is arranged and configured to mount, engage, or be associated with, the first or top surface of the physical interface or LGA socket such as, for example, LGA socket 110. For example, the base 510 may be embedded within the LGA socket 110, although other coupling mechanisms are envisioned. The second end 520 includes a contact tip 522 for connecting with a contact pad on the semiconductor package such as, for example, contact pad 135 of the semiconductor package 130.

The intermediate segment 530 may be constructed as a flexible pin body between the first end or base 510 and the second end 520, the flexible pin body comprising a flexible material to allow the contact tip 522 to move from a first position (e.g., original state) to a second position (e.g., a deformed state) in a vertical direction perpendicular to the first or top surface of the physical interface or LGA socket 110. The intermediate segment 530 being arranged and configured to limit movement of the contact tip 522 in a horizontal direction parallel to the first or top surface to within a defined length when in the second position.

As depicted, in one embodiment, the intermediate segment 530 may include multiple bends such as, for example, a first bend 532 and a second bend 534. In addition, the intermediate segment 530 may include first, second, and third sub-segments 536, 538, 540 as defined by the base 510 and the first and second bends 532, 534. That is, as depicted, the socket pin 500 may include multiple segments and multiple bends between segments. For example, as depicted, the socket pin 500 may include a base 510, a first sub-segment 536 extending from the base 510, a first bend 532 extending from the first sub-segment 536, a second sub-segment 538 extending from the first bend 532 to the second bend 534, and a third sub-segment 540 positioned between the second bend 534 and the contact tip 522 (e.g., a first segment positioned between the base and a first bend, the first bend positioned between the first segment and a second segment, and a second bend between the second segment and a third segment).

In the depicted embodiment, the first sub-segment 536 extends vertically from the top surface of the LGA socket 110. The first bend 532 bends in an opposite direction as the second bend 534 (e.g., the first bend 532 bends towards the second bend 534). As such, the second sub-segment 538 may extend in an opposite lateral direction as compared to the third sub-segment 540 such that, at least a portion of the third sub-segment 540 is positioned vertically above the second sub-segment 438. In addition, and/or alternatively, in some embodiments, as illustrated, the first bend 532 may cause the second sub-segment 538 to extend substantially perpendicular relative to the first sub-segment 536. In one embodiment, as illustrated, the length of the second sub-segment 538 may be approximately 0 to 1.4 mm or higher. In the depicted embodiment, the length of the second sub-segment 438 is approximately 1.3 mm.

The socket pins can be manufactured from any suitable material now know or hereafter developed. For example, the socket pins may be manufactured from a metal such as copper with gold plating at the tip, although other materials/metals with good electronic conductivity may also be used.

FIG. 8 illustrates an embodiment of a computing architecture 800. Computing architecture 800 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 800 has a single processor with one core or more than one processor. Note that the term “processor” refers to a processor with a single core or a processor package with multiple processor cores. In at least one embodiment, the computing architecture 800 is representative of the components of a system. More generally, the computing architecture 800 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 800. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 8, computing architecture 800 comprises a system-on-chip (SoC) 802 for mounting platform components. System-on-chip (SoC) 802 is a point-to-point (P2P) interconnect platform that includes a first processor 804 and a second processor 806 coupled via a point-to-point interconnect 870 such as an Ultra Path Interconnect (UPI). In other embodiments, the computing architecture 800 is another bus architecture, such as a multi-drop bus. Furthermore, each of processor 804 and processor 806 are processor packages with multiple processor cores including core(s) 808 and core(s) 810, respectively. While the computing architecture 800 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 804 and chipset 832. Some platforms include additional components and some platforms include sockets to mount the processors and/or the chipset. Furthermore, some platforms do not have sockets (e.g., SoC, or the like). Although depicted as a SoC 802, one or more of the components of the SoC 802 are included in a single die package, a multi-chip module (MCM), a multi-die package, a chiplet, a bridge, and/or an interposer. Therefore, embodiments are not limited to a SoC.

The processor 804 and processor 806 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 804 and/or processor 806. Additionally, the processor 804 need not be identical to processor 806.

Processor 804 includes an integrated memory controller (IMC) 820 and point-to-point (P2P) interface 824 and P2P interface 828. Similarly, the processor 806 includes an IMC 822 as well as P2P interface 826 and P2P interface 830. IMC 820 and IMC 822 couple the processor 804 and processor 806, respectively, to respective memories (e.g., memory 816 and memory 818). Memory 816 and memory 818 are portions of the main memory (e.g., a dynamic random-access memory (DRAM)) for the platform such as double data rate type 4 (DDR4) or type 5 (DDR5) synchronous DRAM (SDRAM). In the present embodiment, the memory 816 and the memory 818 locally attach to the respective processors (i.e., processor 804 and processor 806). In other embodiments, the main memory couple with the processors via a bus and shared memory hub. Processor 804 includes registers 812 and processor 806 includes registers 814.

Computing architecture 800 includes chipset 832 coupled to processor 804 and processor 806. Furthermore, chipset 832 are coupled to storage device 850, for example, via an interface (I/F) 838. The I/F 838 may be, for example, a Peripheral Component Interconnect-enhanced (PCIe) interface, a Compute Express Link® (CXL) interface, or a Universal Chiplet Interconnect Express (UCIe) interface. Storage device 850 stores instructions executable by circuitry of computing architecture 800 (e.g., processor 804, processor 806, GPU 848, accelerator 854, vision processing unit 856, or the like).

Processor 804 couples to the chipset 832 via P2P interface 828 and P2P 834 while processor 806 couples to the chipset 832 via P2P interface 830 and P2P 836. Direct media interface (DMI) 876 and DMI 878 couple the P2P interface 828 and the P2P 834 and the P2P interface 830 and P2P 836, respectively. DMI 876 and DMI 878 is a high-speed interconnect that facilitates, e.g., eight Giga Transfers per second (GT/s) such as DMI 3.0. In other embodiments, the processor 804 and processor 806 interconnect via a bus.

The chipset 832 comprises a controller hub such as a platform controller hub (PCH). The chipset 832 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (12Cs), and the like, to facilitate connection of peripheral devices on the platform. In other embodiments, the chipset 832 comprises more than one controller hub such as a chipset with a memory controller hub, a graphics controller hub, and an input/output (I/O) controller hub.

In the depicted example, chipset 832 couples with a trusted platform module (TPM) 844 and UEFI, BIOS, FLASH circuitry 846 via I/F 842. The TPM 844 is a dedicated microcontroller designed to secure hardware by integrating cryptographic keys into devices. The UEFI, BIOS, FLASH circuitry 846 may provide pre-boot code. The I/F 842 may also be coupled to a network interface circuit (NIC) 880 for connections off-chip.

Furthermore, chipset 832 includes the I/F 838 to couple chipset 832 with a high-performance graphics engine, such as, graphics processing circuitry or a graphics processing unit (GPU) 848. In other embodiments, the computing architecture 800 includes a flexible display interface (FDI) (not shown) between the processor 804 and/or the processor 806 and the chipset 832. The FDI interconnects a graphics processor core in one or more of processor 804 and/or processor 806 with the chipset 832.

The computing architecture 800 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 854 and/or vision processing unit 856 are coupled to chipset 832 via I/F 838. The accelerator 854 is representative of any type of accelerator device (e.g., a data streaming accelerator, cryptographic accelerator, cryptographic co-processor, an offload engine, etc.). One example of an accelerator 854 is the Intel® Data Streaming Accelerator (DSA). The accelerator 854 is a device including circuitry to accelerate copy operations, data encryption, hash value computation, data comparison operations (including comparison of data in memory 816 and/or memory 818), and/or data compression. Examples for the accelerator 854 include a USB device, PCI device, PCIe device, CXL device, UCIe device, and/or an SPI device. The accelerator 854 also includes circuitry arranged to execute machine learning (ML) related operations (e.g., training, inference, etc.) for ML models. Generally, the accelerator 854 is specially designed to perform computationally intensive operations, such as hash value computations, comparison operations, cryptographic operations, and/or compression operations, in a manner that is more efficient than when performed by the processor 804 or processor 806. Because the load of the computing architecture 800 includes hash value computations, comparison operations, cryptographic operations, and/or compression operations, the accelerator 854 greatly increases performance of the computing architecture 800 for these operations.

The accelerator 854 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 854. For example, the accelerator 854 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 854 via a non-posted write (e.g., a deferred memory write (DMWr)). One example of an instruction that atomically submits a work descriptor to the shared work queue of the accelerator 854 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 854. The dedicated work queue may accept job submissions via commands such as the movdir64b instruction.

Various I/O devices 860 and display 852 couple to the bus 872, along with a bus bridge 858 which couples the bus 872 to a second bus 874 and an I/F 840 that connects the bus 872 with the chipset 832. In one embodiment, the second bus 874 is a low pin count (LPC) bus. Various input/output (I/O) devices couple to the second bus 874 including, for example, a keyboard 862, a mouse 864 and communication devices 866.

Furthermore, an audio I/O 868 couples to second bus 874. Many of the I/O devices 860 and communication devices 866 reside on the system-on-chip (SoC) 802 while the keyboard 862 and the mouse 864 are add-on peripherals. In other embodiments, some or all the I/O devices 860 and communication devices 866 are add-on peripherals and do not reside on the system-on-chip (SoC) 802.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including,” “includes,” “having,” “has,” “with,” or variants thereof are used in either the detailed description or the claims, such terms are intended to be inclusive in a manner similar to the term “comprising.” Additionally, in situations wherein one or more numbered items are discussed (e.g., a “first X,” a “second X,” etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general-purpose computer as selectively activated or reconfigured by a computer program stored in the computer. The procedures presented herein are not inherently related to a particular computer or other apparatus. Various general-purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The following examples pertain to further embodiments, from which numerous permutations and configurations will be apparent.

Example 1. An apparatus, comprising a physical interface to connect a semiconductor package and a printed circuit board (PCB), the physical interface comprising a first surface, a plurality of socket pins mounted to the first surface to connect to the semiconductor package, and a second surface to connect to the PCB; and wherein a socket pin of the plurality of socket pins comprises a first end mounted to the first surface of the physical interface, a second end comprising a contact tip for connection with a contact pad of the semiconductor package, and a flexible pin body between the first end and the second end, the flexible pin body comprising a flexible material to allow the contact tip to move from a first position to a second position in a vertical direction perpendicular to the first surface, and to limit movement of the contact tip in a horizontal direction parallel to the first surface to within a defined length when in the second position.

Example 2. The apparatus of example 1, wherein the flexible pin body comprises multiple segments and multiple bends between segments.

Example 3. The apparatus of example 1, wherein the flexible pin body comprises a first segment extending from the first end, a second segment extending from the second end, a first bend positioned between the first segment and the first end, and a second bend between the first segment and the second segment.

Example 4. The apparatus of example 3, wherein the first segment comprises a negative angle.

Example 5. The apparatus of example 1, wherein the flexible pin body comprises a first bend positioned adjacent to the first end; a first sub-segment extending from the first bend to a second bend; and a second sub-segment positioned between the second bend and the contact tip.

Example 6. The apparatus of example 5, wherein the first bend is configured in an opposite direction as compared to the second bend.

Example 7. The apparatus of example 1, wherein the flexible pin body comprises first, second, and third bends, and first, second, and third sub-segments.

Example 8. The apparatus of example 7, wherein the first bend is positioned adjacent to the first end; the first sub-segment extends from the first bend to the second bend; the second sub-segment extends from the second bend to the third bend; and the third sub-segment is positioned between the third bend and the contact tip.

Example 9. The apparatus of example 8, wherein the first bend is configured to bend in an opposite direction as the second bend; the third bend is configured to bend in an opposite direction as the second bend; and the first and third bends are configured to bend in the same direction.

Example 10. The apparatus of example 1, comprising a metal load plate coupled to the first surface or the second surface, the metal load plate comprising a hinge to pivot over the semiconductor package when connected to the physical interface.

Example 11. The apparatus of example 10, comprising a lever coupled to the metal load plate, the lever to lock the semiconductor package in place when connected to the physical interface.

Example 12. The apparatus of example 1, wherein the physical interface is a socket comprising a mechanical interface and an electrical interface to connect to the semiconductor package when positioned in the socket and disconnect from the semiconductor package when removed from the socket.

Example 13. The apparatus of example 1, wherein the physical interface is a land grid array (LGA) socket.

Example 14. A system, comprising a semiconductor including a first surface, a second surface opposite the first surface, and a plurality of contact pads; a physical interface to connect the semiconductor to a printed circuit board (PCB), the physical interface comprising a first surface, a plurality of socket pins mounted to the first surface, each of the plurality of socket pins arranged and configured to contact one of the plurality of contact pads, and a second surface to connect to the PCB; and wherein a socket pin of the plurality of socket pins comprises a first end mounted to the first surface of the physical interface, a second end comprising a contact tip for connection with a contact pad of the semiconductor package, and a flexible pin body between the first end and the second end, the flexible pin body comprising a flexible material to allow the contact tip to move from a first position to a second position in a vertical direction perpendicular to the first surface, and to limit movement of the contact tip in a horizontal direction parallel to the first surface to within a defined length when in the second position.

Example 15. The system of example 14, wherein the flexible pin body comprises multiple segments and multiple bends between segments.

Example 16. The system of example 14, wherein the flexible pin body comprises a first segment extending from the first end, a second segment extending from the second end, a first bend positioned between the first segment and the first end, and a second bend between the first segment and the second segment.

Example 17. The system of example 14, wherein the first segment comprises a negative angle.

Example 18. A system, comprising a semiconductor package including a semiconductor, a heatsink, a thermal interface material arranged and configured to couple the heatsink to the semiconductor, the semiconductor including a first surface arranged and configured to receive the thermal interface material, a second surface opposite the first surface, and a plurality of contact pads extending from the second surface; a printed circuit board (PCB) including a physical interface to connect the semiconductor to the PCB, the physical interface comprising a first surface, a plurality of socket pins mounted to the first surface, each of the plurality of socket pins arranged and configured to contact one of the plurality of contact pads, and a second surface to connect to the PCB; and wherein a socket pin of the plurality of socket pins comprises a first end mounted to the first surface of the physical interface, a second end comprising a contact tip for connection with a contact pad of the semiconductor package, and a flexible pin body between the first end and the second end, the flexible pin body comprising a flexible material to allow the contact tip to move from a first position to a second position in a vertical direction perpendicular to the first surface, and to limit movement of the contact tip in a horizontal direction parallel to the first surface to within a defined length when in the second position.

Example 19. The system of example 18, wherein the flexible pin body comprises multiple segments and multiple bends between segments.

Example 20. The system of example 18, wherein the flexible pin body comprises a first segment extending from the first end, a second segment extending from the second end, a first bend positioned between the first segment and the first end, and a second bend between the first segment and the second segment.

Example 21. A method, comprising: mounting a plurality of socket pins to a first surface of a physical interface to connect to a semiconductor package, wherein a socket pin of the plurality of socket pins comprises a first end mounted to the first surface of the physical interface, a second end comprising a contact tip for connection with a contact pad of the semiconductor package, and a flexible pin body between the first end and the second end, the flexible pin body comprising a flexible material to allow the contact tip to move from a first position to a second position in a vertical direction perpendicular to the first surface, and limiting movement of the contact tip in a horizontal direction parallel to the first surface to within a defined length when in the second position; connecting the semiconductor package to the physical interface; and forming an electrical connection between the contact pad of the semiconductor package and a printed circuit board (PCB) using the physical interface.

Example 22. The method of example 21, wherein the flexible pin body comprises multiple segments and multiple bends between segments.

Example 23. The method of example 21, wherein the flexible pin body comprises a first segment extending from the first end, a second segment extending from the second end, a first bend positioned between the first segment and the first end, and a second bend between the first segment and the second segment.

Example 24. The method of example 23, wherein the first segment comprises a negative angle.

Example 25. The method of example 21, wherein the flexible pin body comprises a first bend positioned adjacent to the first end; a first sub-segment extending from the first bend to a second bend; and a second sub-segment positioned between the second bend and the contact tip.

Example 26. The method of example 25, wherein the first bend is configured in an opposite direction as compared to the second bend.

Example 27. The method of example 21, wherein the flexible pin body comprises first, second, and third bends, and first, second, and third sub-segments.

Example 28. The method of example 27, wherein the first bend is positioned adjacent to the first end; the first sub-segment extends from the first bend to the second bend; the second sub-segment extends from the second bend to the third bend; and the third sub-segment is positioned between the third bend and the contact tip.

Example 29. The method of example 28, wherein the first bend is configured to bend in an opposite direction as the second bend; the third bend is configured to bend in an opposite direction as the second bend; and the first and third bends are configured to bend in the same direction.

Example 30. The method of example 21, comprising connecting a metal load plate to the first surface or the second surface, the metal load plate comprising a hinge to pivot over the semiconductor package when connected to the physical interface.

Example 31. The method of example 10, comprising connecting a lever to the metal load plate, the lever to lock the semiconductor package in place when connected to the physical interface.

Example 32. The method of example 21, comprising: disconnecting the semiconductor package from the physical interface; and removing the electrical connection between the contact pad of the semiconductor package and the PCB by the physical interface

Example 33. The method of example 1, wherein the physical interface is a land grid array (LGA) socket.

Example 34. An apparatus, comprising: means for mounting a plurality of socket pins to a first surface of a physical interface to connect to a semiconductor package, wherein a socket pin of the plurality of socket pins comprises a first end mounted to the first surface of the physical interface, a second end comprising a contact tip for connection with a contact pad of the semiconductor package, and a flexible pin body between the first end and the second end, the flexible pin body comprising a flexible material to allow the contact tip to move from a first position to a second position in a vertical direction perpendicular to the first surface, and limiting movement of the contact tip in a horizontal direction parallel to the first surface to within a defined length when in the second position; means for connecting the semiconductor package to the physical interface; and means for forming an electrical connection between the contact pad of the semiconductor package and a printed circuit board (PCB) using the physical interface.

Other examples are described and claimed herein. Embodiments are not limited to these examples.

What is claimed is:

1. An apparatus, comprising:
a physical interface to connect a semiconductor package and a printed circuit board (PCB), the physical interface comprising a first surface, a plurality of socket pins mounted to the first surface to connect to the semiconductor package, and a second surface to connect to the PCB; and
wherein a socket pin of the plurality of socket pins comprises a first end mounted to the first surface of the physical interface, a second end comprising a contact tip for connection with a contact pad of the semiconductor package, and a flexible pin body between the first end and the second end, the flexible pin body comprising a flexible material to allow the contact tip to move from a first position to a second position in a vertical direction perpendicular to the first surface, and to limit movement of the contact tip in a horizontal direction parallel to the first surface to within a defined length when in the second position.

2. The apparatus of claim 1, wherein the flexible pin body comprises multiple segments and multiple bends between segments.

3. The apparatus of claim 1, wherein the flexible pin body comprises a first segment extending from the first end, a second segment extending from the second end, a first bend positioned between the first segment and the first end, and a second bend between the first segment and the second segment.

4. The apparatus of claim 3, wherein the first segment comprises a negative angle.

5. The apparatus of claim 1, wherein the flexible pin body comprises:
a first bend positioned adjacent to the first end;
a first sub-segment extending from the first bend to a second bend; and
a second sub-segment positioned between the second bend and the contact tip.

6. The apparatus of claim 5, wherein the first bend is configured in an opposite direction as compared to the second bend.

7. The apparatus of claim 1, wherein the flexible pin body comprises first, second, and third bends, and first, second, and third sub-segments.

8. The apparatus of claim 7, wherein:
the first bend is positioned adjacent to the first end;
the first sub-segment extends from the first bend to the second bend;
the second sub-segment extends from the second bend to the third bend; and
the third sub-segment is positioned between the third bend and the contact tip.

9. The apparatus of claim 8, wherein:
the first bend is configured to bend in an opposite direction as the second bend;
the third bend is configured to bend in an opposite direction as the second bend; and
the first and third bends are configured to bend in the same direction.

10. The apparatus of claim 1, comprising a metal load plate coupled to the first surface or the second surface, the metal load plate comprising a hinge to pivot over the semiconductor package when connected to the physical interface.

11. The apparatus of claim 10, comprising a lever coupled to the metal load plate, the lever to lock the semiconductor package in place when connected to the physical interface.

12. The apparatus of claim 1, wherein the physical interface is a socket comprising a mechanical interface and an electrical interface to connect to the semiconductor package when positioned in the socket and disconnect from the semiconductor package when removed from the socket.

13. The apparatus of claim 1, wherein the physical interface is a land grid array (LGA) socket.

14. A system, comprising:
a semiconductor package including a first surface, a second surface opposite the first surface, and a plurality of contact pads;
a physical interface to connect the semiconductor package to a printed circuit board (PCB), the physical interface comprising a first surface, a plurality of socket pins mounted to the first surface, each of the plurality of socket pins arranged and configured to contact one of the plurality of contact pads, and a second surface to connect to the PCB; and
wherein a socket pin of the plurality of socket pins comprises a first end mounted to the first surface of the physical interface, a second end comprising a contact tip for connection with a contact pad of the semiconductor package, and a flexible pin body between the first end and the second end, the flexible pin body comprising a flexible material to allow the contact tip to move from a first position to a second position in a vertical direction perpendicular to the first surface, and to limit movement of the contact tip in a horizontal direction parallel to the first surface to within a defined length when in the second position.

15. The system of claim 14, wherein the flexible pin body comprises multiple segments and multiple bends between segments.

16. The system of claim 14, wherein the flexible pin body comprises a first segment extending from the first end, a second segment extending from the second end, a first bend positioned between the first segment and the first end, and a second bend between the first segment and the second segment.

17. The system of claim 14, wherein the first segment comprises a negative angle.

18. A system, comprising:
a semiconductor package including an integrated circuit, the semiconductor package comprising a first surface, a second surface opposite the first surface, and a plurality of contact pads extending from the second surface;
a printed circuit board (PCB); and
a physical interface mounted to the PCB to connect the semiconductor package to the PCB, the physical interface comprising a first surface, a plurality of socket pins mounted to the first surface, each of the plurality of socket pins arranged and configured to contact one of the plurality of contact pads, and a second surface to connect to the PCB; and
wherein a socket pin of the plurality of socket pins comprises a first end mounted to the first surface of the physical interface, a second end comprising a contact tip for connection with a contact pad of the semiconductor package, and a flexible pin body between the first end and the second end, the flexible pin body comprising a flexible material to allow the contact tip to move from a first position to a second position in a vertical direction perpendicular to the first surface, and to limit movement of the contact tip in a horizontal direction parallel to the first surface to within a defined length when in the second position.

19. The system of claim 18, wherein the flexible pin body comprises multiple segments and multiple bends between segments.

20. The system of claim 18, wherein the flexible pin body comprises a first segment extending from the first end, a second segment extending from the second end, a first bend positioned between the first segment and the first end, and a second bend between the first segment and the second segment.
